(19) United States
(12) Patent Application Publication
(10) Pub. No.: US 2024/0344709 A1
(43) Pub. Date: Oct. 17, 2024

(54) COOKTOP APPLIANCE AND METHODS OF BURNER LEVEL RESPONSE

(71) Applicant: Haier US Appliance Solutions, Inc., Wilmington, DE (US)

(72) Inventors: Isabella Mari Cuasay, Louisville, KY (US); Sarah Virginia Morris, Louisville, KY (US)

(21) Appl. No.: 18/300,893

(22) Filed: Apr. 14, 2023

(51) Int. Cl. F24C 7/08; G01N 27/22; H05B 3/74

(52) U.S. Cl. CPC F24C 7/083; G01N 27/22; H05B 3/74

(57) ABSTRACT

A cooktop appliance may include a cooktop plate, a capacitance grid, a plurality of burners, and a controller. The cooktop plate may define an upper cooking surface. The capacitance grid may be mounted to the cooktop plate. Each burner of the plurality of burners may include an electric heating element mounted below the cooktop plate. The controller may be operatively coupled to the capacitance grid and the plurality of burners. The controller may be configured to direct a cooking operation including receiving a plurality of capacitance signals from the capacitance grid, detecting a capacitance delta based on the plurality of capacitance signals, identifying a burner level of an engaged burner of the plurality of burners based on the detected capacitance delta, and directing a responsive action on the cooktop appliance based on the identified burner level.

### FIELD OF THE INVENTION

The present subject matter relates generally to cooktop appliances, and more particularly to features and methods for detecting conditions on a cooktop appliance.

### BACKGROUND OF THE INVENTION

Cooktop or range appliances generally include heating elements for heating cooking utensils, such as pots, pans, and griddles. A variety of configurations can be used for the heating elements located on the cooking surface of the cooktop. The number of heating elements or positions available for heating on the range appliance can include, for example, four, six, or more depending upon the intended application and preferences of the buyer. These heating elements can vary in size, location, and capability across the appliance.

Existing appliances present a number of drawbacks. For instance, in existing systems, it can be difficult to determine when a burner is active. This can be especially true for burners having electric heating elements. Some systems have attempted to incorporate LED indicators apart from the burners, but these can be difficult to see or determine which burner is hot. Additionally or alternatively, it may be difficult for a user to know if a burner is operating properly (e.g., actively heating or heating to a certain temperature, level, etc.). Although temperature sensors have been incorporated into certain systems, these may have a limited detection coverage or add bulk to the system.

As a result, it would be useful to have an appliance, system, or method to address one or more of the above-identified issues. As an example, it would be advantageous to provide an appliance, system, or method for detecting and alerting a user to the burner status of one or more systems. As an additional or alternative example, it would be advantageous to provide an appliance, system, or method for detecting temperature or burner level at multiple locations on a cooktop (e.g., separately or independently from a dedicated temperature sensor).

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a cooktop appliance is provided. The cooktop appliance may include a cooktop plate, a capacitance grid, a plurality of burners, and a controller. The cooktop plate may define an upper cooking surface. The capacitance grid may be mounted to the cooktop plate. Each burner of the plurality of burners may include an electric heating element mounted below the cooktop plate. The controller may be operatively coupled to the capacitance grid and the plurality of burners. The controller may be configured to direct a cooking operation including receiving a plurality of capacitance signals from the capacitance grid, detecting a capacitance delta based on the plurality of capacitance signals, identifying a burner level of an engaged burner of the plurality of burners based on the detected capacitance delta, and directing a responsive action on the cooktop appliance based on the identified burner level.

In another exemplary aspect of the present disclosure, a method of operating a cooktop appliance is provided. The method may include receiving a plurality of capacitance signals from a capacitance grid mounted to a cooktop plate of the cooktop appliance. The method may also include detecting a capacitance delta based on the plurality of capacitance signals. The method may further include identifying a burner level of an engaged burner of the plurality of burners based on the detected capacitance delta. The method may still further include directing a responsive action on the cooktop appliance based on the identified burner level.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a top, plan view of a cooktop appliance according to exemplary embodiments of the present disclosure.

FIG. 2 provides a top, plan view of a capacitive grid on a cooktop according to exemplary embodiments of the present disclosure.

FIG. 3 provides a top, plan view of the exemplary capacitive grid of FIG. 2, further illustrating burner activation or temperature detection thereon.

FIG. 4 provides a top, plan view of the exemplary capacitive grid of FIG. 2, further object or utensil detection thereon.

FIG. 5 provides a flow chart illustrating a method of operating a cooktop appliance according to exemplary embodiments of the present disclosure.

FIG. 6 provides a flow chart illustrating a method of operating a cooktop appliance according to exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction).

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

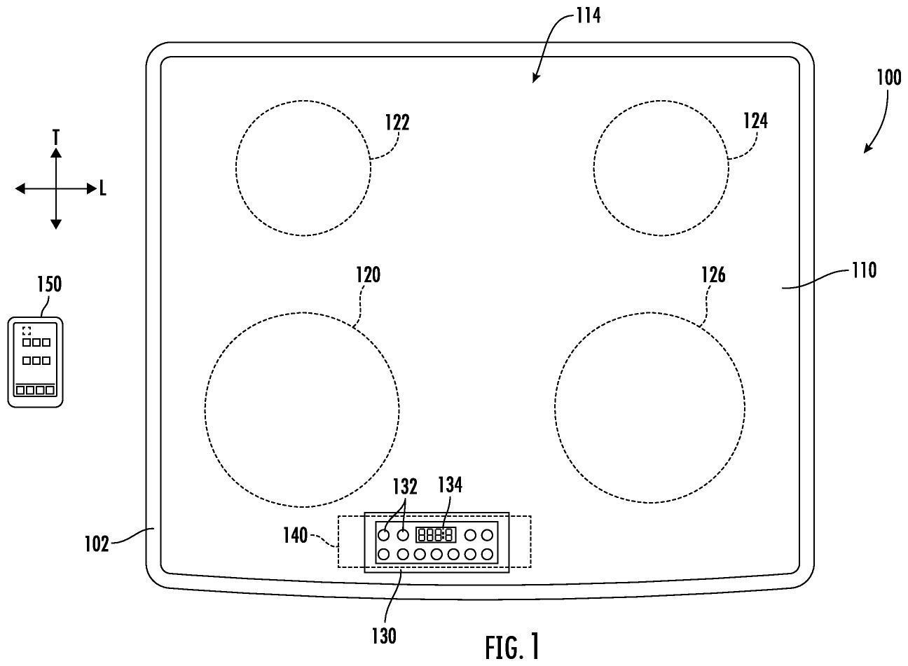

Turning now to the figures, FIG. 1 provides a top, plan view of a cooktop appliance 100 according to exemplary embodiments of the present disclosure. Cooktop appliance 100 can be installed in various locations such as in cabinetry in a kitchen, with one or more ovens to form a range appliance, or as a standalone appliance. Thus, as used herein, the term “cooktop appliance” includes grill appliances, stove appliances, range appliances, and other appliances that incorporate cooktops.

According to exemplary embodiments, appliance 100 includes a cabinet 102 that is generally configured for containing or supporting various components of appliance 100 and which may also define one or more internal chambers or compartments of appliance 100. In this regard, as used herein, the terms “cabinet,” “housing,” and the like are generally intended to refer to an outer frame or support structure for appliance 100, (e.g., including any suitable number, type, and configuration of support structures formed from any suitable materials, such as a system of elongated support members, a plurality of interconnected panels, or some combination thereof.) It should be appreciated that cabinet 102 does not necessarily require an enclosure and may simply include open structure supporting various elements of appliance 100. By contrast, cabinet 102 may enclose some or all portions of an interior of cabinet 102. It should be appreciated that cabinet 102 may have any suitable size, shape, and configuration while remaining within the scope of the present subject matter.

Cabinet 102 generally defines a mutually orthogonal vertical, lateral, and transverse direction. Cabinet 102 extends between a top and a bottom along the vertical direction, between a first side (e.g., the left side when viewed from the front as in FIG. 1) and a second side (e.g., the right side when viewed from the front as in FIG. 1) along the lateral direction L, and between a front and a rear along the transverse direction T. In general, terms such as “left,” “right,” “front,” “rear,” “top,” or “bottom” are used with reference to the perspective of a user accessing appliance 100.

Cooktop appliance 100 includes a cooktop plate 110 (e.g., mounted to cabinet 102) for supporting cooking utensils, such as pots or pans, on a cooking or top surface 114 of cooktop plate 110. Optionally, cooktop plate 110 may be fixed or secured to cabinet 102 at its perimeter edge (e.g., such that the sides or edges of cooktop plate 110 rest on a more rigid structure—or are otherwise prevented from deflected more than—a central portion of cooktop plate 110). When assembled, a top cook surface 114 is directed vertically upward to contact cooking utensils, while a bottom interior surface is directed vertically downward opposite the top surface 114 (e.g., toward a support panel mounted below cooktop plate 110). Cooktop plate 110 may be any suitable rigid plate, such as one formed of ceramic or glass (e.g., glass ceramic). As will be described in greater detail below, one or more burners or heating assemblies 120, 122, 124 are mounted below cooktop plate 110 such that heating assemblies 120, 122, 124, and 126 are positioned below cooktop plate 110 (e.g., below a bottom interior surface along the vertical direction). Cooktop plate 110 may be continuous over heating assemblies 120, 122, 124, and 126. Thus, no holes may extend vertically through cooktop plate 110 above heating assemblies 120, 122, 124, and 126.

While shown with four heating assemblies 120, 122, 124, and 126 in the exemplary embodiment of FIG. 1, cooktop appliance 100 may include any number of heating assemblies 120, 122, 124, and 126 in alternative embodiments. Heating assemblies 120, 122, 124, and 126 can also have various diameters. For example, each heating assembly of heating assemblies 120, 122, 124, and 126 can have a different diameter, the same diameter, or any suitable combination thereof. In addition, the heating elements 120, 122, 124, and 126 may include differing numbers or shapes of electric heating elements, as would be understood. Nonetheless, cooktop appliance 100 is provided by way of example only and is not limited to the exemplary embodiment shown in FIG. 1. For example, a cooktop appliance having one or more radiant heating assemblies in combination with one or more electric resistance or gas burner heating elements can be provided. In addition, various combinations of number of heating assemblies, position of heating assemblies or size of heating assemblies can be provided.

Generally, a user interface 130 provides visual information to a user and allows a user to select various options for the operation of cooktop appliance 100. For example, displayed options can include a desired heating assemblies 120, 122, 124, and 126, a desired cooking temperature, or other options. User interface 130 can be any type of suitable input device and can have any suitable configuration. In FIG. 1, user interface 130 is located within a portion of cooktop plate 110. Alternatively, user interface 130 can be positioned on a vertical surface near a front side of cooktop appliance 100 or at another location that is convenient for a user to access during operation of cooktop appliance 100.

In some embodiments, such as that shown in FIG. 1, user interface 130 includes a capacitive touch screen input device component 132. Capacitive touch screen input device component 132 can allow for the selective activation, adjustment or control of any or all heating assemblies 120, 122, 124, and 126 as well as any timer features or other user adjustable inputs. One or more of a variety of electrical, mechanical, or electro-mechanical input devices including rotary dials, push buttons, toggle/rocker switches, or touch pads can also be used singularly or in combination with capacitive touch screen input device component 132. User interface 130 also includes a display component 134, such as a digital or analog display device designed to provide operational feedback to a user.

Generally, cooktop appliance 100 includes a controller 140. Operation of cooktop appliance 100 is regulated by controller 140 (e.g., according to one or more cooking operation, such as method 500 or 600, described below). Controller 140 is operatively coupled or in communication with various components of cooktop appliance 100, including user interface 130. In response to user manipulation of the user interface 130, controller 140 operates the various components of cooktop appliance 100 to execute selected cycles and features.

Controller 140 may include memory (e.g., non-transitory media) and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 140 may be constructed without using a microprocessor (e.g., using a combination of discrete analog or digital logic circuitry, such as switches, amplifiers, integrators, comparators, flip-flops, AND gates, and the like) to perform control functionality instead of relying upon software. Heating assemblies (e.g., 120, 124, 122, or 126), user interface 130 and other components of cooktop appliance 100 may be in communication with controller 140 via one or more signal lines or shared communication busses.

In some embodiments, controller 140 includes a network interface and is configured to communicate with a separate device external to cooktop appliance 100, referred to generally herein as a remote user device 150. As described in more detail below, these communications may be facilitated using a wired or wireless connection, such as via a network. Such a network may include one or more of a local area network (LAN), a wide area network (WAN), a personal area network (PAN), the Internet, a cellular network, any other suitable short-or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), or protection schemes (e.g., VPN, secure HTTP, SSL).

In general, remote user device 150 may be any suitable device separate from cooktop appliance 100 that is configured to provide or receive communications, information, data, or commands from a user. In this regard, remote user device 150 may be, for example, a personal phone, a smartphone, a tablet, a laptop or personal computer, a wearable device, a smart home system, or another mobile or external device.

Optionally, the remote user device 150 may include or be able to access a software application for interacting with the one or more appliances. For instance, the remote user device 150 may be provided or associated with a particular user profile to interact with and operate multiple discrete home appliances (e.g., oven, refrigerator, dishwasher, washing machine, or dryer appliances).

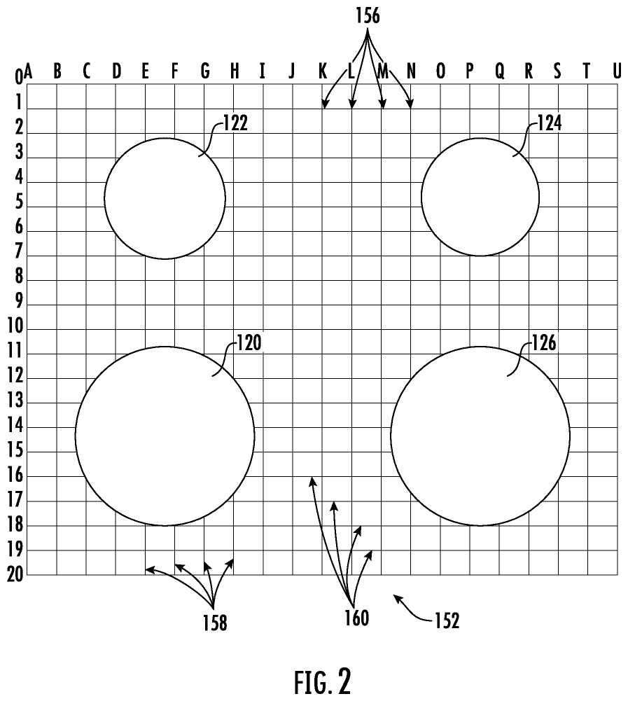

Turning now to FIGS. 1 through 4, various portions of the exemplary appliance 100 are illustrated and will be described in greater detail. In particular, a capacitance grid 152 is illustrated. Generally, capacitance grid 152 is configured for detecting variations in the capacitance electrical field across the horizontal area covered by capacitance grid 152. Such embodiments may be configured to analyze and identify one or more points, protrusions, or surfaces (e.g., of an object or utensil 154A, 154B) coming into contact with cooktop surface 114. As shown, capacitance grid 152 includes multiple discrete (e.g., parallel) conductive wires or electrode elements arranged according to a set coordinate system array and intersecting each other at separate mutual capacitance keys 156. For instance, capacitance grid 152 may include a multi-layer capacitance array. In exemplary embodiments, two perpendicular electrode layers and may be joined (e.g., to one or more substrates) to facilitate directly analyzing points across the X-axis and the Y-axis. Specifically, a first electrode layer may include a plurality of mutually-parallel detection electrode elements 158 extending in the same direction (e.g., transverse direction T). A second electrode layer may include a plurality of mutually-parallel detection electrode elements 160 extending in the same direction (e.g., the lateral direction L) orthogonal to the direction of the first electrode layer. Both electrode layers may then be positioned adjacent to each other in attachment with a uniform substrate.

When assembled, capacitance grid 152 generally extends across or over at least a portion of the cooktop plate 110. In turn, capacitance grid 152 is generally positioned above the heating assemblies 120, 122, 124, 126. Moreover, capacitance grid 152 is operatively coupled (e.g., with one or more wires or busses) to controller 140 such that controller 140 may receive one or more capacitance signals from capacitance grid 152. The electrode layers (e.g., with mutual capacitance keys 156) may form a predetermined or set coordinate system. In turn, variations in capacitance may be detected at the keys 156 (e.g., as would be understood) and identified as coordinate locations on the set coordinate system.

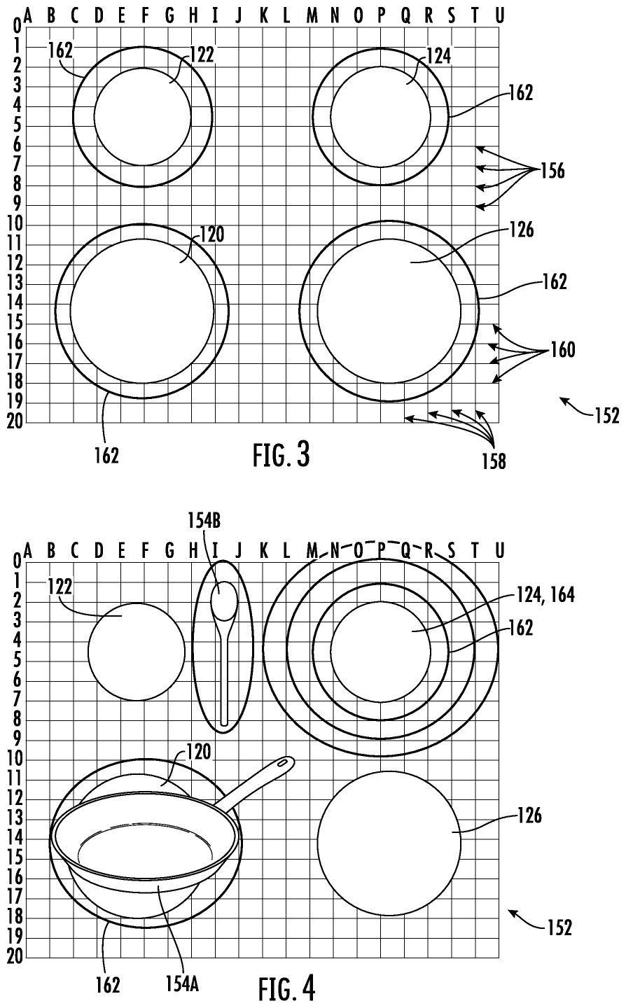

Turning especially to FIGS. 3 and 4, in some embodiments, a corresponding outline 162 is provided for each burner 120, 122, 124, 126. For instance, each burner 120, 122, 124, or 126 may have an outline 162 that is predefined to surround the corresponding burner 120, 122, 124, or 126. Such an outline 162 may be generally matched to the burner 120, 122, 124, or 126 and radially spaced apart from the same (e.g., by a set horizontal or radial distance). As shown, the outline 162 may intersect one or more location keys 156 adjacent to the corresponding burner 120, 122, 124, or 126. Optionally, one or more keys 156 may be linked to a corresponding burner 120, 122, 124, or 126. Such location keys 156 may line within the outline 162 for the corresponding burner 120, 122, 124, or 126. As an example, the location keys 156 at F10, J14, F19, and B14 may be linked to the burner 120. As an additional or alternative example, the location keys 156 at F1, I4, F8, and C4 may be linked to the burner 122. As another additional or alternative example, the location keys 156 at P1, S4, P8, and M4 may be linked to the burner 124. As yet another additional or alternative example, the location keys 156 at P10, S14, P19, and M14 may be linked to the burner 126.

Generally, variations in capacitance at one or more keys 156 may be detected and used to determine one or more conditions on the cooktop surface 114. Optionally, the presence of an item or object (e.g., utensil 154A or 154B) on one or more keys 156 (and the corresponding change or increase in capacitance) may facilitate identifying or locating such an item or object. As an example, the presence of a utensil 154A on one or more matched keys 156 may indicate the that the corresponding burner 120, 122, 124, or 126 is being engaged (e.g., prepared for use). As an additional or alternative example, the presence of an offset utensil 154B (and the corresponding change or increase in capacitance) spaced apart from a burner 120, 122, 124, or 126 on one or more keys 156 (e.g., apart from the matched keys 156), may indicate that such an item may need to be moved or protected (e.g., by limiting heat output at one or more adjacent burner 120, 122, 124, 126). Additionally or alternatively, changes in heat (and the corresponding change or increase in capacitance) from a corresponding (e.g., active) burner 164 may facilitate identifying or measuring temperature from the active burner 164. As an example, heat-generated capacitance changes at one or more matched keys 156 may indicate the corresponding burner 120, 122, 124, or 126 is being engaged (e.g., in use as an active burner 164).

Now that the construction of cooktop appliance 100 according to exemplary embodiments has been presented, exemplary methods (e.g., methods 500 and 600) of operating a cooktop appliance will be described. Although the discussion below refers to the exemplary methods 500 and 600 of operating cooktop appliance 100, one skilled in the art will appreciate that the exemplary methods 500 and 600 are applicable to the operation of a variety of other cooktop appliances, such as an oven or range appliance. In exemplary embodiments, the various method steps as disclosed herein may be performed (e.g., in whole or part) by controller 140 or another separate controller.

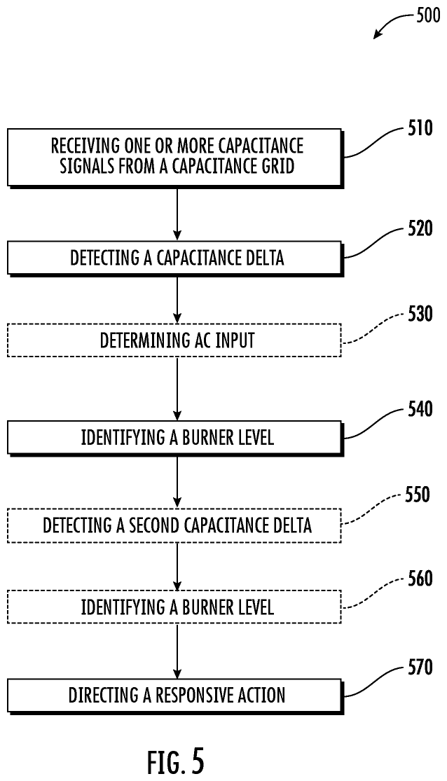

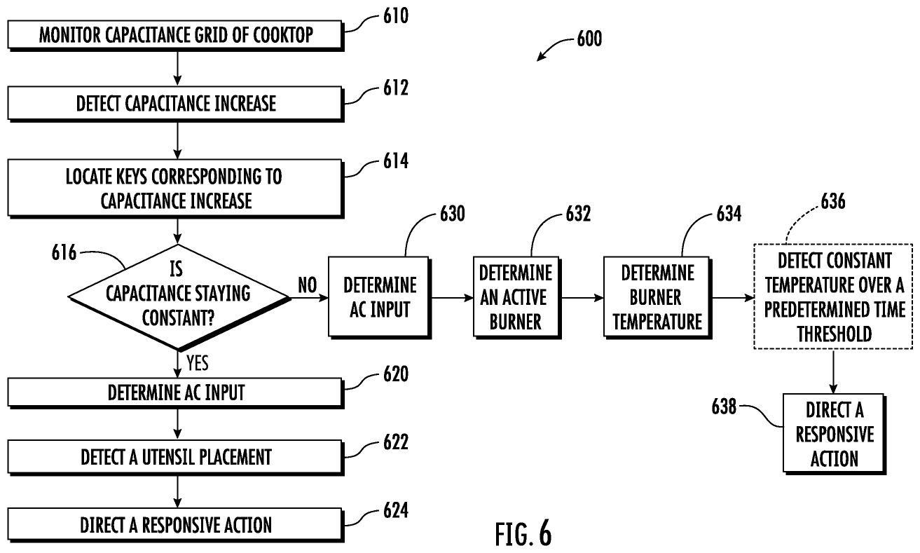

FIGS. 5 and 6 depict steps performed in a particular order for purpose of illustration and discussion. Those of ordinary skill in the art, using the disclosures provided herein, will understand that (except as otherwise indicated) methods 500 and 600 are not mutually exclusive. Moreover, the steps of the methods 500 and 600 can be modified, adapted, rearranged, omitted, interchanged, or expanded in various ways without deviating from the scope of the present disclosure.

Advantageously, methods in accordance with the present disclosure may detect and alert a user to the burner status of one or more systems. Additionally or alternatively, such methods may advantageously address objects on a cooktop (e.g., automatically or without direct user input). Additionally or alternatively, such methods may advantageously detect temperature at multiple locations on a cooktop (e.g., separately or independently from a dedicated temperature sensor).

Turning especially to FIG. 5, at 510, the method 500 includes receiving one or more capacitance signals from a capacitance grid. In particular, 510 may include one or more signals received from the capacitance grid at one or more keys. As described above, mutual capacitance keys may generally form a predetermined or set coordinate system such that variations in capacitance detected on the capacitance grid (e.g., as would be understood) may be located according to the corresponding points, locations, coordinates, or keys. Thus, 510 may include receiving a plurality of capacitance signals from a plurality of points, locations, coordinates, or keys. For instance, multiple capacitance signals may be received (e.g., at or corresponding to different points in time) from each point of the plurality of points on the grid. Optionally, the plurality of points may correspond to a common burner (e.g., be set along the same outline corresponding to a discrete burner). In some embodiments, 510 includes monitoring the capacitance grid (e.g., over time or according to a set rate or schedule) such that capacitance signals and variations in capacitance over time may be received, recorded, or otherwise tracked.

At 520, the method 500 includes detecting a (e.g., first) capacitance delta based on the plurality of capacitance signals. In particular, a difference between a first (e.g., initial) capacitance signal and a second (e.g., subsequent or later in time) capacitance signal may be determined. Notably, the first and second capacitance signals may be received from a common key or point on the capacitance grid, but at different points in time. Thus, 520 may detect the change in capacitance for at least one point over time.

Optionally, the change in capacitance for multiple discrete points over time (e.g., the same time interval) may be detected. For instance, 520 may include detecting the capacitance delta comprises detecting a plurality of capacitance deltas corresponding to discrete points of the plurality of points. As noted above, the plurality of points, locations, coordinates, or keys may be along a predetermined outline surrounding the corresponding burner. In certain embodiments, the plurality of capacitance deltas for the plurality of points can be used to generate a single value or variable, such as a unified delta. Specifically, 520 may include determining a unified delta from the detected plurality of capacitance deltas. For instance, the unified delta may be calculated with or according to a predetermined formula, chart, graph, or look-up table (e.g., having multiple variables, each corresponding to different capacitance deltas of the plurality of capacitance deltas). As an example, determining the unified delta includes calculating a mean delta value from the plurality of capacitance deltas. The mean delta value may be an average of the plurality of capacitance values (e.g., each corresponding to a common burner, outline, or time interval, as described above). Additionally or alternatively, the mean delta value may be used as the unified delta.

At 520, the method 500 includes detecting a (e.g., first) capacitance increase based on the capacitance signals at 510. In particular, the capacitance signals received at 510 may indicate a capacitance increase at one or more discrete keys. Thus, an individual capacitance increase may correspond to one or more discrete keys (e.g., over time).

In some embodiments, the increase at 520 is gradual. In other words, the detected capacitance increase at 520 may include a gradual increase having multiple discrete rises in the capacitance value (e.g., over a predetermined period of time). Thus, there may be a ramp up from an initial spike in capacitance to a later-detected maximum (e.g., at the same point, location, coordinate, or key on the capacitance grid). The gradual increase may be within a predetermined range or rate of capacitance increase. Additionally or alternatively, the detected gradual increase may be determined to be located at a plurality of points, locations, coordinates, or keys. Such points, locations, coordinates, or keys may be along a predetermined outline surrounding the corresponding burner. Optionally, the detected gradual increase may be correlated to a rise in temperature (e.g., according to a predetermined formula, chart, graph, or lookup table, as would be understood). Thus, temperature at the corresponding coordinates or locations (e.g., one or more locations) on the capacitance grid may be determined based on the detected capacitance increase. Additionally or alternatively, it may be determined that temperature at the corresponding locations is maintained at a constant temperature (e.g., above a set temperature threshold) over or in excess of a predetermined time threshold. Thus, it may be detected if the temperature at a burner is elevated or constant for too long (e.g., without requiring or relying solely on a dedicated temperature sensor).

In additional or alternative, the increase at 520 is static or constant. In other words, the detected capacitance increase at 520 may be substantially instant. Moreover, the detected capacitance increase at 520 may remain constant over a predetermined period of time. Thus, there may be an instant and steady spike in capacitance. Such an instant and steady spike may rise to its maximum immediately or otherwise above a predetermined range, rate, or threshold of capacitance increase. Additionally or alternatively, the detected static or constant increase may be determined to be located at a plurality of points, locations, coordinates, or keys. Such points, locations, coordinates, or keys may be along a predetermined outline surrounding the corresponding burner. Optionally, values of the capacitance increase or the shape of capacitance increases on the grid may be correlated to specific utensils or metals. Thus, one or more characteristics of a detected utensil may be identified (e.g., based on the capacitance signals at 510).

At 530, the method 500 includes optionally determining alternating current (AC) input. For instance, the controller may evaluate the AC signal to one or more burners. Thus, the controller may determine if a significant AC signal is being directed to one or more of the burners.

As an example, 530 may include detecting an AC signal to a particular burner above a set threshold. In other words, it may be detected and determined that the particular burner is receiving a significant AC load to activate the same. Optionally, the particular burner may be the same burner that is corresponds to the detected capacitance delta (e.g., at 520).

As an additional or alternative example, 530 may include detecting an AC signal below the set threshold. In other words, it may be detected and determined that the particular burner is not receiving a significant AC load and is, thus, not intended to be active (i.e., intended to be inactive).

At 540, the method 500 includes identifying a (e.g., first) burner level (e.g., of or corresponding to one or more heating elements). Such an identification may be based, at least in part, the detected capacitance delta at 520. For instance, the detected capacitance delta, plurality of deltas, or unified delta may be used as a variable or variable set in a predetermined formula, chart, graph, or look-up table to calculate, ascertain, or otherwise determine the burner level (e.g., as an exact burner level, such as a temperature value or a discrete burner level of a plurality of predetermined burner levels). In some such embodiments, multiple predetermined burner levels or temperatures are provided, each corresponding to a discrete delta value or value range. Generally, higher capacitance deltas may correspond to higher burner levels or temperatures. As a purely illustrative example, the burner levels may include a nil burner level corresponding to a nil delta value range of 0-24, a low burner level corresponding to a low delta value range of 25-40, a medium burner level corresponding to a medium delta value range of 41-75, and a high burner level corresponding to a high delta value range of 76-100. Thus, the detected capacitance delta or unified delta may be compared to the predetermined delta value ranges to identify which burner level the corresponding burner or heating element is at.

In certain embodiments, 540 includes detecting a constant burner level over a predetermined time threshold. For instance, it may be determined that temperature at the corresponding locations is maintained at a constant temperature (e.g., above a set temperature threshold) over or in excess of a predetermined time threshold. In some such embodiments, a preset timer (e.g., of the predetermined time threshold) is engaged or started in response to detecting a new burner level. If no additional or subsequent new burner level is detected prior to expiration of the preset timer, it may be determined that a constant burner level is detected over the predetermined time threshold. In turn, it may be detected if the temperature at a burner is elevated or constant for too long (e.g., without requiring or relying solely on a dedicated temperature sensor).

In additional or alternative embodiments, 540 includes determining an active burner based on the capacitance delta (e.g., prior to determining an exact burner level, such as a temperature value or a discrete burner level of a plurality of predetermined burner levels). As an example, wherein the determined temperature delta includes or is identified as a gradual increase having multiple discrete rises in the capacitance value over a predetermined period of time (e.g., along a predetermined outline surrounding the corresponding burner), it may be indicated that the corresponding burner is being engaged (e.g., as an active burner). Optionally, determining the active burner is further based on the detected AC signal at 530. As an example, identification of an engaged burner (e.g., as an active burner) may further include detecting an AC signal above the set threshold. Optionally, identification of an active burner may be contingent on one or both determinations of a significant AC load and a gradual capacitance increase.

In certain embodiments, prior to or in tandem with 540, the method 500 includes identifying an engaged burner (i.e., one or more heating elements separate from or identical to the active burner at 540). Such an identification may be based, at least in part, on the detected capacitance delta at 520 being a detected capacitance increase. As an example, wherein the detected capacitance increase includes a gradual increase having multiple discrete rises in the capacitance value over a predetermined period of time (e.g., along a predetermined outline surrounding the corresponding burner), it may be indicated that the corresponding burner is being engaged (e.g., as an active burner). As an additional or alternative example, when the detected capacitance increase includes an increased capacitance remaining constant over a predetermined period of time (e.g., along a predetermined outline surrounding the corresponding burner), it may be indicated that the corresponding burner is being engaged (e.g., as a burner that has received a utensil placement thereon).

At 550, the method 500 includes optionally detecting a second capacitance delta based on the plurality of capacitance signals (e.g., following 520, 530, or 540). In particular, a difference between a third (e.g., initial) capacitance signal and a fourth (e.g., subsequent or later in time) capacitance signal may be determined. Notably, the third and fourth capacitance signals may be received from a common key or point on the capacitance grid, but at different points in time. Thus, 550 may detect the change in capacitance for at least one point over time. Optionally, the second capacitance delta may be detected from capacitance signals from the same points (e.g., points, coordinates, or keys) as those of the first capacitance delta or, alternatively, from capacitance signals from different points.

In some embodiments, 550 includes detecting a (e.g., second) capacitance increase based on the capacitance signals at 510. For instance, separate from or in addition to 520 through 540, the capacitance signals received at 510 may indicate a capacitance increase at one or more discrete keys (e.g., separate or spaced apart from those corresponding to 520). Thus, an individual capacitance increase may correspond to one or more discrete keys. Optionally, the capacitance increase at 550 may be located at keys spaced apart from those corresponding to the outline at any burners.

In some embodiments, the burner level detected at 540 is static or constant. For instance, a detected capacitance increase corresponding to 540 may be substantially instant. Moreover, the detected capacitance increase at 540 may remain constant over a predetermined period of time. Thus, there may be an instant and steady spike in capacitance. Such an instant and steady spike may rise to its maximum immediately or otherwise above a predetermined range, rate, or threshold of capacitance increase. Additionally or alternatively, the detected burner level at 540 may be a nil burner level. Further additionally or alternatively, the detected static or constant increase may be determined to be located at a plurality of points, locations, coordinates, or keys. Such points, locations, coordinates, or keys (e.g., at least some of the points, locations, coordinates, or keys) may be apart from any predetermined outline surrounding (or according to a set radial distance from) the corresponding burner. Optionally, values of the capacitance increase or the shape of capacitance increases on the grid may be correlated to specific utensils or metals. Thus, one or more characteristics of a detected utensil may be identified (e.g., based on the capacitance signals at 540).

At 560, the method 500 includes optionally identifying a (e.g., second) burner level (e.g., of or corresponding to one or more heating elements). Such an identification may be based, at least in part, the detected capacitance delta at 550. For instance, the detected capacitance delta, plurality of deltas, or unified delta may be used as a variable or variable set in a predetermined formula, chart, graph, or look-up table to calculate, ascertain, or otherwise determine the burner level (e.g., as an exact burner level, such as a temperature value or a discrete burner level of a plurality of predetermined burner levels). In some such embodiments, multiple predetermined burner levels or temperatures are provided, each corresponding to a discrete delta value or value range (e.g., as described above).

In optional embodiments, 560 further includes detecting an offset utensil (e.g., apart from one or more burners). For instance, the detected offset utensil may be spaced apart from an active burner (e.g., as identified at 540). As an alternative example, wherein the detected capacitance increase at 550 comprises an increased capacitance remaining constant over a predetermined period of time (e.g., apart from a predetermined outline surrounding any burner or at a nil burner level), it may be indicated that an offset utensil is on the cooktop surface.

At 570, the method 500 includes directing a responsive action (e.g., in response to 540, 550, or 560). Such responsive actions may include one or more alerts (e.g., prompted at the control panel or remote user device), such as a visual or auditory message, visual indicator (e.g., illuminated icon or visible engagement map), audible alarm or alert tone, etc. As an example, identification of an engaged burner may displayed (e.g., on the control panel or remote user device). As an additional or alternative example, an alarm may be prompted or directed (e.g., on the control panel or remote user device). For instance, an excess-time alarm may be prompted or directed at the control panel (e.g., in response to detecting a constant temperature over a predetermined time threshold). As another additional or alternative example, identification of an offset utensil may displayed (e.g., on the control panel or remote user device).

Such response actions may further include controlling one or more burners. As an example, if a utensil is not detected on a burner, activation thereof may be restricted. For instance, detection of a utensil on one burner may prompt a responsive action permitting activation of the corresponding engaged burner (e.g., while restricting activation of any remaining non-engaged burners). As an additional or alternative example, if certain utensils (e.g., characteristics thereof) are detected, activation of one or more burners may be restricted. For instance, detection of an offset utensil or identification of a predetermined unsuitable utensil may prompt a responsive action restricting activation of one or more burners. As another additional or alternative example, an active burner may be restricted or adjusted to an inactive state (e.g., in response to detecting a constant temperature over a predetermined time threshold).

Turning now especially to FIG. 6, at 610, the method 600 includes monitoring the capacitance grid of the cooktop. In particular, 610 may include monitoring or measuring variations in capacitance levels at the capacitance grid. Thus, 610 may include receiving one or more capacitance signals from the capacitance grid. For instance, 610 may include one or more signals received from the capacitance grid at one or more keys. As described above, mutual capacitance keys may generally form a predetermined or set coordinate system such that variations in capacitance detected on the capacitance grid (e.g., as would be understood) may be located according to the corresponding coordinates and keys. In some embodiments, 610 includes monitoring the capacitance grid (e.g., over time or according to a set rate or schedule) such that capacitance signals and variations in capacitance over time may be received, recorded, or otherwise tracked.

At 612, the method 600 includes detecting a capacitance increase (e.g., with a temperature delta) based on the capacitance signals at 610. Thus, the monitoring at 610 may lead to a detected variation representing an increase in capacitance values on the cooktop surface.

At 614, the method 600 includes locating keys on the grid coordinate system corresponding to the capacitance increase at 612. In particular, the capacitance signals received at 610 and detected at 612 may indicate a capacitance increase at one or more discrete keys. Thus, an individual capacitance increase may correspond to one or more discrete keys (e.g., a discrete location, point, coordinate, or key on the capacitance grid) that may be referenced from the memory of the controller to determine the location on the coordinate system that corresponds to the detected capacitance increase. Optionally, such points, coordinates, or keys may be along a predetermined outline surrounding the corresponding burner.

At 616, the method 600 includes evaluating the consistency of the capacitance increase. In other words, it may be evaluated if the capacitance increase is constant or, alternatively, gradual. As an example, if constant, the detected capacitance increase at 6120 may be substantially instant. Moreover, the detected capacitance increase at 612 may remain constant over a predetermined period of time. Thus, there may be an instant and steady spike in capacitance on the located keys. Such an instant and steady spike may rise to its maximum immediately or otherwise above a predetermined range, rate, or threshold of capacitance increase. As an additional or alternative example, if not constant, the detected capacitance increase at 612 may include a gradual increase having multiple discrete rises in the capacitance value (e.g., over a predetermined period of time). Thus, there may be a ramp up from an initial spike in capacitance to a later-detected maximum at the located keys. The gradual increase may be within a predetermined range or rate of capacitance increase.

If the capacitance increase is constant, the method 600 may proceed to 620. By contrast, if the capacitance increase is not constant, the method 600 may proceed to 630.

At 620, the method 600 includes determining alternating current (AC) input. For instance, the controller may evaluate the AC signal to one or more burners. Thus, the controller may determine if a significant AC signal is being directed to one or more of the burners. As an example, 620 may include detecting an AC signal below the set threshold. In other words, it may be detected and determined that the particular burner is not receiving a significant AC load and is, thus, not intended to be active (i.e., intended to be inactive).

At 622, the method 600 includes detecting a utensil placement (e.g., based on 612, 614, 616, or 620). As an example, when the detected capacitance increase includes an increased capacitance remaining constant over a predetermined period of time (e.g., along a predetermined outline surrounding the corresponding burner), it may be indicated a burner corresponding to the located keys has received a utensil placement thereon. As an additional or alternative example, wherein 620 includes detecting an AC signal below the set threshold, a burner corresponding to the located keys may be determined to be inactive. As a further additional or alternative example, the located keys may be determined to be spaced apart from the burners. In turn, an offset utensil may be detected.

Optionally, values of the capacitance increase or the shape of capacitance increases on the grid may be correlated to specific utensils or metals. Thus, one or more characteristics of a detected utensil of the utensil placement may be identified (e.g., based on the capacitance signals at 610).

At 624, the method 600 includes directing a responsive action (e.g., in response to 620 or 622). Such responsive actions may include one or more alerts (e.g., prompted at the control panel or remote user device), such as a visual or auditory message, visual indicator (e.g., illuminated icon or visible engagement map), audible alarm or alert tone, etc. As an example, a determined utensil or utensil placement may displayed (e.g., on the control panel or remote user device). As an example, such response actions may include controlling one or more burners. As an additional or alternative example, detection of a utensil on one burner may prompt a responsive action permitting activation of the corresponding engaged burner (e.g., while restricting activation of any remaining non-engaged burners). As another additional or alternative example, if certain utensils (e.g., characteristics thereof) are detected, activation of one or more burners may be restricted. For instance, detection of an offset utensil or identification of a predetermined unsuitable utensil may prompt a responsive action restricting activation of one or more burners.

Returning to 630, at 630, the method 600 includes determining alternating current (AC) input. For instance, the controller may evaluate the AC signal to one or more burners. Thus, the controller may determine if a significant AC signal is being directed to one or more of the burners. As an example, 630 may include detecting an AC signal above the set threshold. In other words, it may be detected and determined that the particular burner is receiving a significant AC load and is, thus, intended to be active.

At 632, the method 600 includes determining an active burner. As an example, wherein the detected capacitance increase includes a gradual increase having multiple discrete rises in the capacitance value over a predetermined period of time (e.g., along a predetermined outline surrounding the corresponding burner), it may be indicated that the corresponding burner is being engaged as an active burner. As an additional or alternative example, determination of an active burner may further include detecting an AC signal above the set threshold at 630.

At 634, the method 600 includes determining burner temperature (i.e., a burner level of the active burner based on 612, 614, 616, 630, or 632). Generally, the detected gradual increase in capacitance may be correlated to a rise in temperature Such an identification may be based, at least in part, the detected capacitance delta or increase at 612. For instance, the detected capacitance delta, plurality of deltas, or unified delta may be used as a variable or variable set in a predetermined formula, chart, graph, or look-up table to calculate, ascertain, or otherwise determine the burner level (e.g., as an exact burner level, such as a temperature value or a discrete burner level of a plurality of predetermined burner levels). In some such embodiments, multiple predetermined burner levels or temperatures are provided, each corresponding to a discrete delta value or value range. Generally, higher capacitance deltas may correspond to higher burner levels or temperatures. As a purely illustrative example, the burner levels may include a nil burner level corresponding to a nil delta value range of 0-24, a low burner level corresponding to a low delta value range of 25-40, a medium burner level corresponding to a medium delta value range of 41-75, and a high burner level corresponding to a high delta value range of 76-100. Thus, the detected capacitance delta or unified delta may be compared to the predetermined delta value ranges to identify which burner level the corresponding burner or heating element is at. Thus, temperature at the corresponding locations (e.g., active burner) on the capacitance grid may be determined based on the detected capacitance increase.

At 636, the method 600 includes optionally detecting a constant temperature over a predetermined time threshold (e.g., at the active burner). In other words, it may be determined that temperature at the active burner is maintained at a constant temperature (e.g., above a set temperature threshold) over or in excess of a predetermined time threshold. Thus, it may be detected if the temperature at the active burner is elevated or constant for too long (e.g., without requiring or relying solely on a dedicated temperature sensor).

At 638, the method 600 includes directing a responsive action (e.g., in response to 632, 634, or 636). Such responsive actions may include one or more alerts (e.g., prompted at the control panel or remote user device), such as a visual or auditory message, visual indicator (e.g., illuminated icon or visible engagement map), audible alarm or alert tone, etc. As an example, identification of an engaged burner may displayed (e.g., on the control panel or remote user device). As an additional or alternative example, an alarm may be prompted or directed (e.g., on the control panel or remote user device). For instance, an excess-time alarm may be prompted or directed at the control panel (e.g., in response to detecting a constant temperature over a predetermined time threshold).

Such response actions may further include controlling one or more burners. As an example, an active burner may be restricted or adjusted to an inactive state (e.g., in response to detecting a constant temperature over a predetermined time threshold).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooktop appliance, comprising:
a cooktop plate defining an upper cooking surface;
a capacitance grid mounted to the cooktop plate;
a plurality of burners, each burner of the plurality of burners comprising an electric heating element mounted below the cooktop plate; and
a controller operatively coupled to the capacitance grid and the plurality of burners, the controller being configured to direct a cooking operation comprising
receiving a plurality of capacitance signals from the capacitance grid,
detecting a capacitance delta based on the plurality of capacitance signals,
identifying a burner level of an engaged burner of the plurality of burners based on the detected capacitance delta, and
directing a responsive action on the cooktop appliance based on the identified burner level.

2. The cooktop appliance of claim 1, wherein the plurality of capacitance signals are received from a plurality of points corresponding to the engaged burner.

3. The cooktop appliance of claim 2, wherein detecting the capacitance delta comprises detecting a plurality of capacitance deltas corresponding to discrete points of the plurality of points.

4. The cooktop appliance of claim 3, wherein detecting the capacitance delta comprises determining a unified delta from the detected plurality of capacitance deltas, and wherein the burner level is further based on the unified delta.

5. The cooktop appliance of claim 4, wherein determining the unified delta comprises calculating a mean delta value from the plurality of capacitance deltas.

6. The cooktop appliance of claim 2, wherein each point of the plurality of points is disposed along a predetermined outline surrounding the common burner.

7. The cooktop appliance of claim 1, further comprising:
a control panel operatively coupled to the controller,
wherein identifying the burner level comprises detecting a constant burner level over a predetermined time threshold, and
wherein directing the responsive action comprises directing an excess-time alarm at the control panel.

8. The cooktop appliance of claim 1, wherein identifying the burner level comprises determining an active burner based on the capacitance delta,

9. The cooktop appliance of claim 8, wherein the cooking operation further comprises detecting an AC signal to the engaged burner above a set threshold, wherein determining the active burner is further based on the detected AC signal.

10. A method of operating a cooktop appliance comprising a cooktop plate defining an upper cooking surface, a capacitance grid mounted to the cooktop plate, a plurality of burners, each burner of the plurality of burners comprising an electric heating element mounted below the cooktop plate, the method comprising:
receiving a plurality of capacitance signals from the capacitance grid;
detecting a capacitance delta based on the plurality of capacitance signals;
identifying a burner level of an engaged burner of the plurality of burners based on the detected capacitance delta; and
directing a responsive action on the cooktop appliance based on the identified burner level.

11. The method of claim 10, wherein the plurality of capacitance signals are received from a plurality of points corresponding to the engaged burner.

12. The method of claim 11, wherein detecting the capacitance delta comprises detecting a plurality of capacitance deltas corresponding to discrete points of the plurality of points.

13. The method of claim 12, wherein detecting the capacitance delta comprises determining a unified delta from the detected plurality of capacitance deltas, and wherein the burner level is further based on the unified delta.

14. The method of claim 13, wherein determining the unified delta comprises calculating a mean delta value from the plurality of capacitance deltas.

15. The method of claim 11, wherein each point of the plurality of points is disposed along a predetermined outline surrounding the common burner.

16. The method of claim 10, wherein identifying the burner level comprises detecting a constant burner level over a predetermined time threshold, and
wherein directing the responsive action comprises directing an excess-time alarm at a control panel of the cooktop appliance.

17. The method of claim 10, wherein identifying the burner level comprises determining an active burner based on the capacitance delta,

18. The method of claim 17, further comprising detecting an AC signal to the engaged burner above a set threshold, wherein determining the active burner is further based on the detected AC signal.
